(19) United States
(12) Patent Application Publication
(10) Pub. No.: US 2007/0066314 A1
(43) Pub. Date: Mar. 22, 2007

(54) System and method for wireless communication systems coexistence

(76) Inventors: Itay Sherman, Raanana (IL); Nir Tal, Haifa (IL)

Correspondence Address: TEXAS INSTRUMENTS INCORPORATED, P O BOX 655474, M/S 3999, DALLAS, TX, 75265, US

(21) Appl. No.: 11/509,312

(22) Filed: Aug. 24, 2006

Related U.S. Application Data
(60) Provisional application No. 60/710,860, filed on Aug. 24, 2005.
(60) Provisional application No. 60/710,840, filed on Aug. 24, 2005.

(51) Int. Cl. H04Q 7/20

(52) U.S. Cl. 455/445

(57) ABSTRACT

System and method for enabling the coexistence of multiple wireless communications on a single unit. A preferred embodiment comprises receiving a schedule of reserved message transfer times from a coexistence unit of a first wireless network in a mobile unit at a coexistence unit of a second wireless network in the mobile unit, selecting an operating mode for the coexistence unit based on the schedule, and transferring messages on the first wireless network and the second wireless network based on the schedule. The first wireless network is restricted to being able to transfer messages only during scheduled times. The sharing of the schedule of reserved message transfer times can enable the transfer of messages in the second wireless network to occur in between the reserved message transfer times, thereby reducing message collisions that can negatively impact data transfer performance of both wireless networks.

This application claims the benefit of U.S. Provisional Application No. 60/710,860, filed on Aug. 24, 2005, entitled “System Level Coexistence between UWB and WLAN and WiMax,” and U.S. Provision Application No. 60/710,840, filed on Aug. 24, 2005, entitled “Co Operation of WLAN and WiMax,” which applications are hereby incorporated herein by reference.

### TECHNICAL FIELD

The present invention relates generally to a method for wireless communications, and more particularly to a system and method for enabling the coexistence of multiple wireless communications systems in a single unit.

### BACKGROUND

The use of wireless communications systems is becoming more widespread, with systems using radio frequency (RF) signals being most prevalent. Wireless communications systems enable great flexibility in movement of electronic units utilizing them as well as reduced implementation costs for both service provider and user in terms of infrastructure and installation costs. Users of electronic units utilizing wireless communications systems can typically move anywhere within the operating range of the communications system without restriction. Therefore, there are a large number of wireless communications systems available today. Some operate at short range only, while others operate at medium and long ranges.

As a result, electronic units are being developed with the ability to use more than one of the widely available wireless communications systems. A single electronic unit capable of using more than one wireless communications system can provide connectivity over a wide range of environments, increasing the convenience for the user. Furthermore, a single electronic unit that can communicate with more than one wireless communications system can reduce the number of electronic devices that users may need to carry around. For example, an electronic unit, such as a cellular telephone or a personal digital assistant (PDA) can communicate using a cellular communications network (such as CDMA, GSM, and so on), a personal area network (such as Bluetooth), a short range wireless local area network (such as WiFi (WLAN)), a long range wireless local area network (such as WiMAX), as well as a wireline replacement (for example, wireless USB (wUSB)). Therefore, a single unit can replace two or three devices, namely, a cellular telephone, a PDA, a laptop computer, and so forth.

If two (or more) wireless communications systems communicate using frequency bands that are spaced far apart, then relatively simple RF filters could prevent any interaction from occurring between the transmissions of the communications systems, i.e., the communications systems can coexist without interfering with one another. However, if the wireless communications systems communicate using frequency bands that are close (or if the frequency bands overlap), then the transmissions of a first communications system can interfere with the reception of transmissions of a second communications system.

Depending on the power levels of the transmissions, the expected sensitivity of reception, the required SNR for reception, the receiver blocking performance, RF filtering, and so forth, one or both of the colliding transmissions can be damaged. For instance, if a first transmission is transmitted with a power level of +20 dbm, and a second transmission is required to be received with sensitivity levels of up to −85 dbm and required SNR of 20 db, a blocking performance of a receiver of first transmission band is 50 db, and filtering provides only 15 db of blocking for the first transmission, then a receiver for the second transmission will suffer +20−15-(−85)+20−50=60 db de-sense which can render reception impractical. In general, a collision can be defined as a condition where the transmissions of two or more communications systems overlap in time and create interference.

With reference now to FIGS. 1a through 1c, there are shown diagrams illustrating an exemplary communications environment, an exemplary mobile unit, and a collision between two transmissions. The diagram shown in FIG. 1a illustrates an exemplary communications environment 100, which includes a mobile unit 105. The mobile unit 105 is capable of communicating with several different wireless communications systems, including a cellular communications network via a cell tower 110, a wireless local area network via an access point 115, a peripheral 120 via a wireline replacement network, and a medium range communications network via a host 125.

The diagram shown in FIG. 1b illustrates a view of a communications subsystem of the mobile unit 105. The mobile unit 105 can have a separate communications block 130 for each of the wireless communications systems with which it is capable of communicating. A single communications block 130 can include a receiver 132 and a transmitter 134 as well as an antenna (not shown) to receive and transmit. Also not shown can be dedicated hardware, such as filters, coders, decoders, and so forth, needed for each of the wireless communications systems.

The diagram shown in FIG. 1c illustrates a collision between a first transmission 150 and a second transmission 155. In this case, the transmissions slightly overlap in frequency, with a collision shown in the hashed box 157. Data transmitted in the overlapping frequency is likely to be corrupted. If a sufficient amount of data is corrupted, the transmission cannot be recovered and the data will need to be retransmitted. With a sufficiently high collision rate, the performance of the communications network can diminish dramatically.

In the prior art, there can be several different classes of techniques usable for handling transmission collisions. A first class of techniques can be classified as collision avoidance. An example of collision avoidance techniques includes changing the transmission frequency to help reduce the probability of collisions (frequency hopping). A second class of techniques can be classified as collision recovery. An example of collision recovery involves the spreading of the data to be transmitted over more spectrum than is needed to transmit the data. This can reduce the damage caused by a collision and, with the use of error correction techniques, the data can be recovered if the damage to the data is less than the ability of the error correction code to correct errors.

One disadvantage of the prior art is that the collision avoidance techniques are passive and do not attempt to actually prevent collisions from occurring. They try to reduce the probability of collision. Therefore, collisions can and still do occur.

Another disadvantage of the prior art is that the collision recovery techniques reduce the overall transmission bandwidth, with the greater error recovery requiring a greater percentage of the overall transmission bandwidth. Therefore, when the chance of collision is low, it may not be possible to effectively maximize the utilization of the available transmission bandwidth. Additionally, regardless of the degree of error recovery used, there is always a chance that a collision will occur that will exceed the error recovery code's ability to correct damaged data.

### SUMMARY OF THE INVENTION

These and other problems are generally solved or circumvented, and technical advantages are generally achieved, by preferred embodiments of the present invention which provides a system and method for enabling the coexistence of multiple wireless communications systems.

In accordance with a preferred embodiment of the present invention, a method for operating a mobile unit is provided. The mobile unit is capable of communicating with a first wireless network and a second wireless network and contains a first coexistence unit associated with the first wireless network and a second coexistence unit associated with the second wireless network. The method includes, at a coexistence unit of a second wireless network, receiving a schedule of reserved messaged transfer times from a coexistence unit of the first wireless network in the mobile unit, and selecting an operating mode based on the schedule. The method further includes transferring messages on the first wireless network and the second wireless network based on the schedule.

In accordance with a preferred embodiment of the present invention, a method for allowing a mobile unit to communicate with two wireless networks, where communications on a first wireless network occurs only during scheduled times, is provided. The method includes receiving a message from a controller of the first wireless network, where the message contains a schedule of message transfer times, and providing the schedule to a coexistence unit for a second wireless network in the mobile unit. The message transfers on the second wireless network are based on the schedule. The method also includes transferring messages on the first wireless network based on the schedule and transferring messages on the second wireless network based on the schedule.

In accordance with another preferred embodiment of the present invention, a communications device is provided. The communications device includes a communications block coupled to an antenna, and a communications unit coupled to the communications block. The communications block receives and transmits signals via the antenna, while the communications unit alternatively communicates with a first device using a first wireless network and a second device using a second wireless network, with the time that the mobile unit communicates using the first wireless network not overlapping with the time that the mobile unit communicates using the second wireless network.

An advantage of a preferred embodiment of the present invention is that the present invention is active in nature, with the bandwidth allocation being partitioned based on the requirements of the communications systems. If a first communications system needs a large amount of bandwidth while a second communications system does not, then a significant portion of the bandwidth can be devoted to the first communications system.

A further advantage of a preferred embodiment of the present invention is that the present invention makes use of existing capabilities of the communications systems and does not require any modifications to the communications systems, which could decrease compatibility while increasing the likelihood of errors.

Yet another advantage of a preferred embodiment of the present invention is the potential ability to reduce the hardware requirements in supporting multiple communications systems. This can reduce the overall cost of the hardware, thereby increasing the profitability of the hardware. Additionally, the reduction in the hardware can lead to a reduction in the size of the hardware, allowing smaller units. Furthermore, reduced hardware can reduce the probability of failure, potentially increasing the reliability of the hardware.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1a through 1c are diagrams of an exemplary communications environment, an exemplary mobile unit, and a transmission collision;

FIGS. 2a and 2b are diagrams of communications subsystems of exemplary mobile units, according to a preferred embodiment of the present invention;

FIGS. 3a through 3c are time-space diagrams of frequency band availability over time for a first and a second wireless network, according to a preferred embodiment of the present invention;

FIGS. 4a and 4b are diagrams of the sequences of events in the operation of a mobile unit's wUSB coexistence unit and WLAN coexistence unit, according to a preferred embodiment of the present invention;

FIGS. 5a and 5b are time-space diagrams of frequency band availability over time for a first and a second wireless network, according to a preferred embodiment of the present invention;

FIGS. 6a through 6d are diagrams of the sequences of events in the operation of a mobile unit's WiMAX coexistence unit and wUSB coexistence unit and exemplary embodiments for processing of transmissions that could create collisions, according to a preferred embodiment of the present invention;

FIGS. 7a and 7b are time-space diagrams of frequency band availability over time for a first and a second wireless network, according to a preferred embodiment of the present invention;

FIGS. 8a through 8d are diagrams of the sequences of events in the operation of a mobile unit's WiMAX coexistence unit and WLAN coexistence unit, a determination of operating mode for the WiMAX and WLAN portions of the mobile unit, and an exemplary embodiment for processing of WLAN transmissions that are too long in duration, according to a preferred embodiment of the present invention; and

FIGS. 9a and 9b are diagrams of high-level views of operations of coexistence units in a mobile unit, according to a preferred embodiment of the present invention.

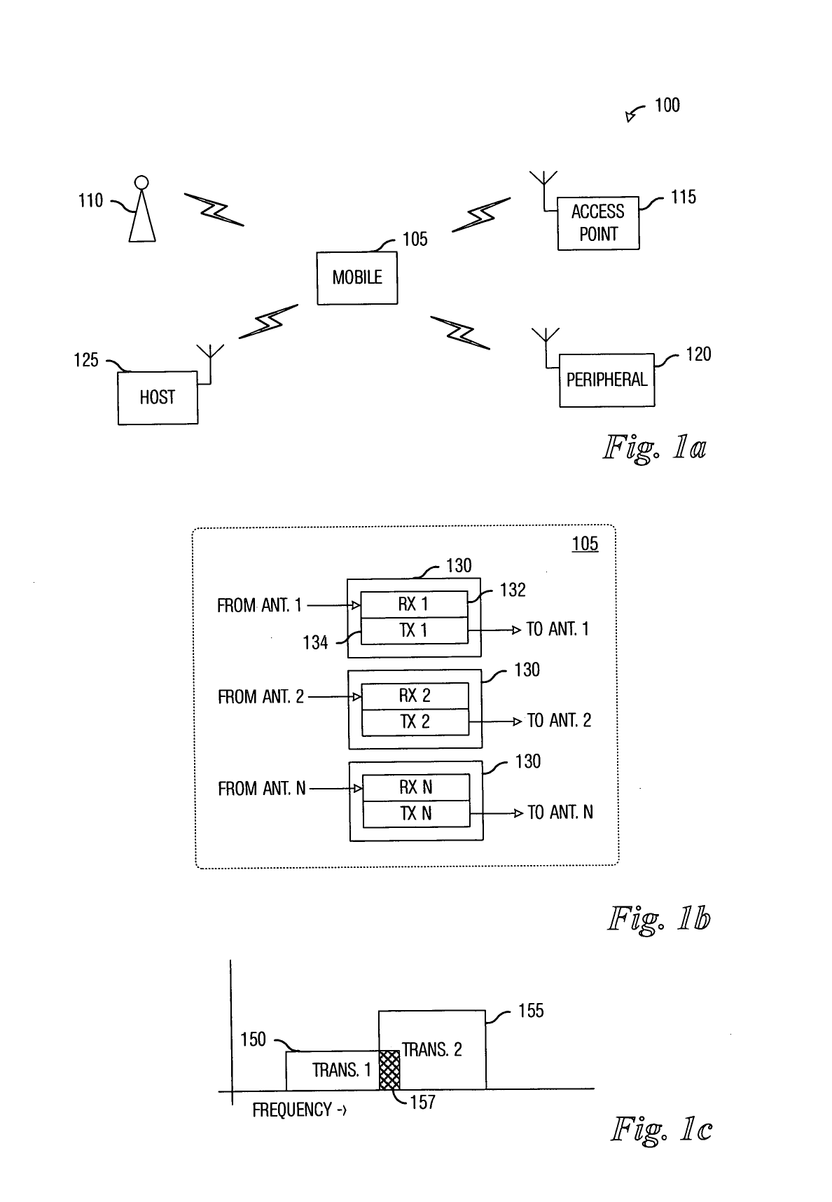

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a mobile unit that is capable of maintaining communications with more than one wireless communications system at the same time, wherein the wireless communications systems can include WLAN, wUSB, and WiMAX. The invention may also be applied, however, to electronic units in general that are capable of maintaining communications with more than one wireless communications system at the same time, wherein the wireless communications systems can include communications systems other than WLAN, wUSB, and WiMax, such as Bluetooth, GSM, CDMA, and so forth.

WLAN (Wireless Local Area Networks) is a name for wireless communications systems, for example, those that are compliant with the IEEE (Institute of Electrical and Electronics Engineers) 802.11 series of technical standards. WLAN systems communicate either in the 2.4 GHz or the 5.8 GHz Unlicensed National Information Infrastructure (UNII) frequency bands, where they are expected to be able to tolerate interference from units sharing the same band and to not cause undue interference. WiMAX (Worldwide Interoperability for Microwave Access) represents longer distance wireless communications systems such as those that are compliant with the IEEE 802.16 series of technical standards. WiMAX systems can transmit using licensed frequency bands at around 2.3 GHz, 2.5 GHz, 3.5 GHz, and 5.8 GHz. Finally, wUSB (Wireless Universal Serial Bus) is a wireless replacement for wired USB and utilizes the Federal Communications Commission's Ultra-WideBand (UWB) transmission restrictions to transmit low-power signals over a very wide frequency band that ranges from 3.1 GHz to 10.6 GHz. It is understood that these specific frequencies could change over time and additional standards may be added while older standards may be removed.

In general, when a low-power transmission (for example, wUSB) collides with a high-power transmission (for example, WLAN or WiMAX), the low-power transmission will not materially affect the high-power transmission. An exception may occur when a receiver of the high-power transmission is extremely close to a transmitter of the low-power transmission. On the other hand, a high-power transmission can severely damage a low-power transmission.

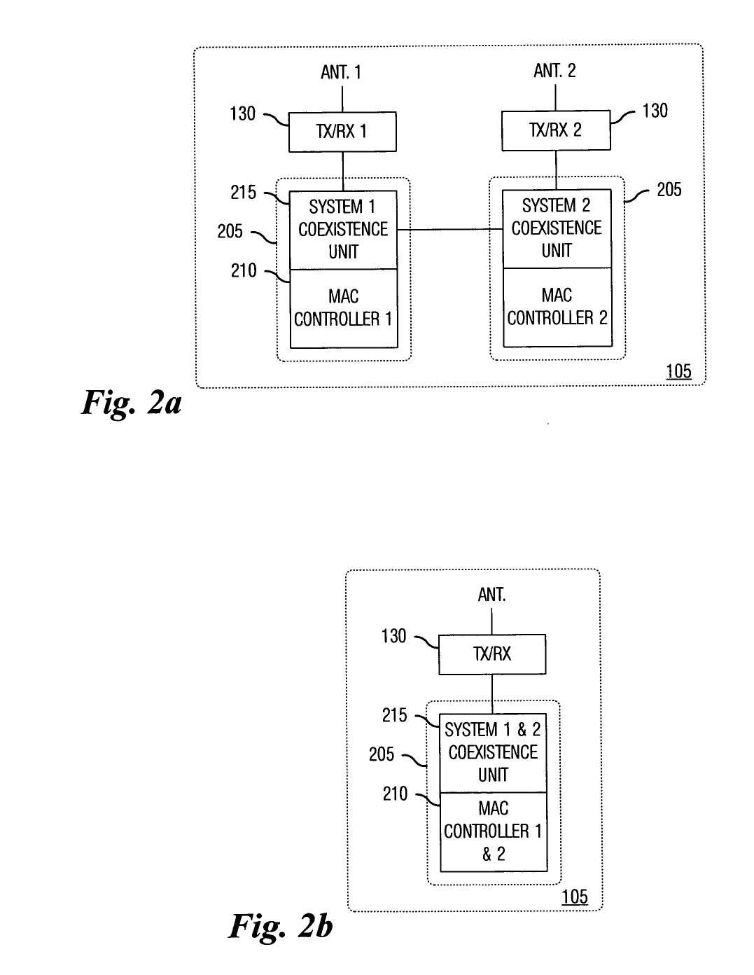

FIGS. 2a and 2b show diagrams illustrating communications subsystems of mobile units, according to a preferred embodiment of the present invention. The diagram shown in FIG. 2a illustrates the communications subsystem of a typical mobile unit 105, wherein the mobile unit 105 communicates to two wireless communications systems where collisions (due to full frequency overlap or mere proximity) can occur between transmissions of the two wireless communications systems. The communications subsystem includes a communications unit 205 for each wireless communications system. The communications unit 205 includes a wireless MAC controller 210 that is specific for the wireless communications system, such as wUSB, WLAN, WiMAX, and so forth, and a system coexistence unit 215. The system coexistence unit 215 can be embedded in the MAC controller 210 or it may be implemented in a separate unit. The system coexistence unit 215 can be responsible for communicating with other system coexistence units in the mobile unit 105 and providing coordination between the different wireless communications subsystems to maximize performance. The system coexistence unit 215 can be coupled to a communications block 130, which, in turn, can be coupled to an antenna (not shown).

The diagram shown in FIG. 2b illustrates a simplification of the communications subsystem of a mobile unit 105. Depending on the coexistence algorithm, it can be possible to share a single communications block 130, a single communications unit 205 (which includes a system coexistence unit 215 and a MAC controller 210), and an antenna (not shown) between the two wireless communications systems. This can reduce the hardware needed to support the multiple wireless communications systems, thereby reducing mobile unit 105 complexity and increasing performance and reliability.

Although the mobile unit 105 is shown in FIGS. 2a and 2b as operating with two wireless communications networks, the present invention can be applied to mobile units that can operate with three or more wireless communications networks. The present invention can be readily extended by those of ordinary skill in the art of the present invention to three or more wireless networks. Therefore the discussion presented should not be construed as being limiting to either the spirit or scope of the present invention.

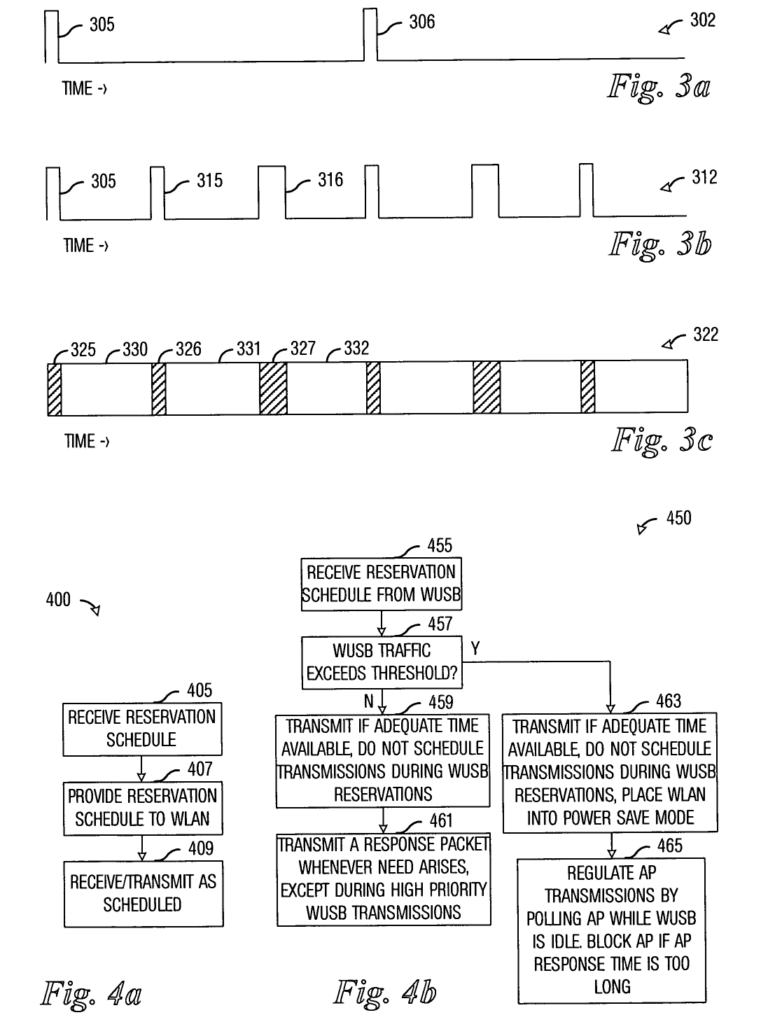

FIGS. 3a through 3c show time-space diagrams illustrating frequency band availability over time, according to a preferred embodiment of the present invention. The diagrams shown in FIGS. 3a through 3c illustrate frequency band availability over time for a mobile unit, wherein the mobile unit is actively maintaining a connection with a wUSB communications network and a WLAN communications network. In such a situation, transmission collisions can occur if the wUSB communications network and the WLAN communications network transmit in the frequency bands at and around 5.8 GHz.

Since wUSB units and hosts of a wUSB communications network can only receive and transmit wUSB packets according to a schedule that is dictated by a wUSB host (and transmitted in the wUSB host's MMCs (micro scheduling message command)), it can be possible to schedule the coexistence of the wUSB communications network and the WLAN communications network using the schedule of the mobile unit's wUSB transmissions and receptions, (whether the schedule is from the wUSB host creating the schedule and transmitted it via an MMC or a wUSB unit receiving the schedule from the wUSB host). The diagram shown in FIG. 3a displays a first trace 302 that can be representative of scheduled wUSB transmission and reception times for the mobile unit, with pulse 305 and pulse 306 representing transmissions from the wUSB host providing the mobile unit acting as a wUSB unit with a schedule of wUSB transmission and reception times.

The transmission and reception schedule transmitted from the wUSB host via an MMC, as received during pulse 305, for example, can be used to reserve the frequency band at specified times. The diagram shown in FIG. 3b illustrates a second trace 312 that shows frequency band availability over time after the mobile unit has received a wUSB transmission and reception schedule. Scheduled transmission and reception times can be seen as pulse 315 and pulse 316, for instance. Scheduled times for wUSB packet transfers are reserved times when considering WLAN packet transfers.

The mobile unit should not transmit any WLAN packets during times that have already been reserved for the wUSB packets (pulse 305, pulse 315, and pulse 316, for example). However, since the mobile unit cannot transmit or receive wUSB packets except at times that are reserved, the mobile unit can transmit or receive WLAN packets at any of the unreserved (times not scheduled for wUSB packet transfers) times. The diagram shown in FIG. 3c illustrates a third trace 322 that shows frequency band availability over time for transmission and reception of WLAN packets. Certain times cannot be used to transmit and receive WLAN packets, such as times reserved for transmitting and receiving wUSB packets (shown in FIG. 3b as pulse 305, pulse 315, and pulse 316), shown in FIG. 3c as dashed box 325, dashed box 326, and dashed box 327. However, any remaining time can be used by the mobile unit to transmit and receive WLAN packets, for example, box 330, box 331, and box 332.

With reference now to FIGS. 4a and 4b, there are shown diagrams illustrating sequences of events in the operation of a mobile unit's wUSB coexistence unit (sequence of events 400, FIG. 4a) and a mobile unit's WLAN coexistence unit (sequence of events 450, FIG. 4b), according to a preferred embodiment of the present invention.

The diagram shown in FIG. 4a illustrates the operation of the mobile unit's wUSB coexistence unit. The wUSB host, to which the wUSB unit (the mobile unit) is communicating, can transmit a transmission and reception schedule to the mobile unit via MMCs. The transmission and reception schedule specifies specific times that the mobile unit can use to transmit or receive packets. The mobile unit cannot receive or transmit outside of the specific scheduled times. Once the mobile unit receives the transmit/receive reservation schedule (block 405), the mobile unit's wUSB coexistence unit can provide the transmit/receive reservation schedule to the WLAN coexistence unit (block 407). The mobile unit can then transmit and receive message bursts (or simply, messages) in the form of wUSB packets as scheduled (block 409).

According to a preferred embodiment of the present invention, wUSB packet traffic can be given a priority level, which can be used to help reduce the probability of collisions of higher priority packets. For example, MMCs, as well as lower layer wUSB beacons can be assigned a high priority. Additionally, specific wUSB end point traffic can also be marked as high priority (for example, the prioritization can be based on the applications using the end points or on the characteristics of the end points). The transmit/receive reservation schedule can include the priority information.

The diagram shown in FIG. 4b illustrates the operation of the mobile unit's WLAN coexistence unit. The WLAN coexistence unit, after receiving the transmit/receive reservation schedule from the wUSB coexistence unit (block 455) can determine if the wUSB packet traffic is high by comparing the reservations with a specified threshold (block 457). For example, if the transmit/receive reservation schedule has reserved more than a certain percentage of the available time, then the wUSB packet traffic can be deemed to be high. If the wUSB packet traffic is not high, then the mobile unit's WLAN packet traffic can be scheduled to occur within the times not reserved by the wUSB traffic (block 459). For example, WLAN packet traffic can be transmitted during blocks 330 through 332 (FIG. 3c). An exception to not transmitting during a reserved time can occur when the mobile unit is to transmit an acknowledgment packet or a clear-to-send (CTS) packet, i.e., high priority WLAN packets. According to a preferred embodiment of the present invention, the mobile unit can transmit an acknowledgment packet or a CTS packet during a reserved time as long as the reserved time is not allocated to a high priority wUSB packet traffic (block 461).

However, if the wUSB packet traffic is high, then a significant portion of the available packet transfer time has been reserved for wUSB packets, and the time that can be used for WLAN packets is likely to be insufficiently long to permit the successful transmission of a packet and associated acknowledgment packet. If this is the case, then the mobile unit's WLAN circuitry can be placed in a WLAN power save mode, which can reduce the WLAN packet traffic. Once the mobile unit is placed in the WLAN power save mode, then only WLAN traffic that can be successfully transmitted during an unreserved time slot can be transmitted with no acknowledgment packet or CTS packet transmitted during any wUSB reserved time (block 463). Alternatively, the mobile unit can control WLAN transmissions by polling the WLAN access point (AP) and if the AP responds within the unreserved time slot, then the transmission can be completed. However, if AP does not respond quickly enough, the mobile unit can poll the AP during an unreserved time slot and defer the response from the AP until the next unreserved time slot by transmitting a CTS packet (block 465). In effect, the time required for the WLAN transmission is broken up over two unreserved times.

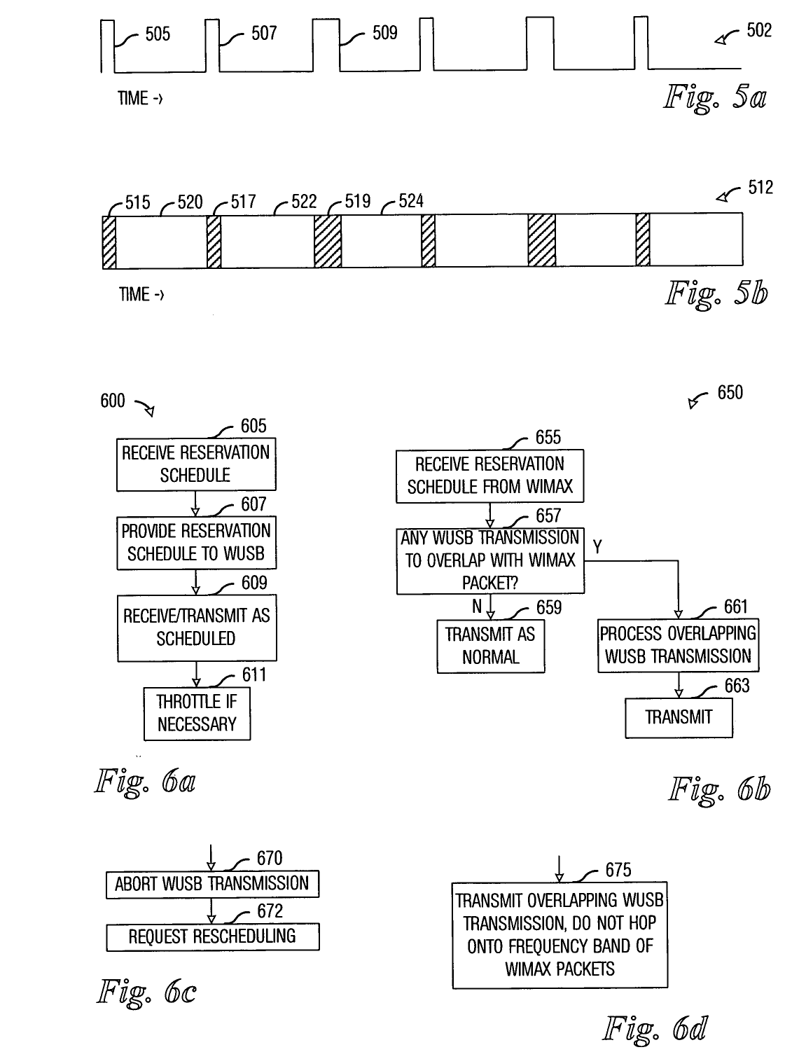

FIGS. 5a and 5b show time-space diagrams illustrating frequency band availability over time, according to a preferred embodiment of the present invention. The diagrams shown in FIGS. 5a and 5b illustrate frequency band availability over time for a mobile unit, wherein the mobile unit is actively maintaining a connection with a wUSB communications network and a WiMAX communications network. Transmission collisions can occur if the wUSB communications network and the WiMAX communications network transmit in the frequency bands at and around 3.5 GHz.

In both wUSB and WiMAX, a mobile unit can transmit and receive only when permitted to do so per a set schedule that is provided by a respective host or base station. However, since WiMAX is typically a pay for use communications system over licensed spectrum, WiMAX communications should be given priority over wUSB communications. The diagram shown in FIG. 5a displays a first trace 502 that can be representative of scheduled WiMAX transmission and reception times for the mobile unit, with pulse 505, pulse 507, and pulse 509, representative of scheduled WiMAX transmissions and receptions. The mobile unit can receive its WiMAX transmission and reception schedule from the WiMAX base station via MAP messages sent on the beginning of every WiMax frame.

Since the mobile unit will not transmit or receive any WiMAX packets outside of the scheduled times, the unscheduled times can be used for wUSB transmissions and receptions. Although wUSB transmissions and receptions are also scheduled, collisions can still occur if a scheduled wUSB transmission or reception occurs within a reserved time. The built-in retry mechanism that is a part of the wUSB communications protocol can help to keep the data throughput loss to a minimum. The diagram shown in FIG. 5b displays a second trace 512 that shows frequency band availability over time for transmission and reception of wUSB packets. Certain times cannot be used to transmit and receive wUSB packets, such as times reserved for transmitting and receiving WiMAX packets (shown in FIG. 5a as pulse 505, pulse 507, and pulse 509). The reserved times are shown in FIG. 5b as dashed boxes 515, 517, and 519. However, any remaining time can be used by the mobile unit to transmit and receive wUSB packets, for example, the time denoted by 520, 522, and 524.

FIGS. 6a through 6d show diagrams illustrating sequences of events in the operation of a mobile unit's WiMAX coexistence unit (sequence of events 600, FIG. 6a) and a mobile unit's wUSB coexistence unit (sequence of events 650, FIG. 6b), as well as exemplary embodiments for processing transmissions that could create collisions, according to a preferred embodiment of the present invention.

The diagram shown in FIG. 6a illustrates the operation of the mobile unit's WiMAX coexistence unit. The WiMAX host, to which the WiMAX unit (the mobile unit) is communicating, can transmit a transmission and reception schedule to the mobile unit, for example, in a MAP (Media Access Protocol) message at the beginning of each WiMAX frame. The transmission and reception schedule specifies specific times that the mobile unit can use to transmit or receive packets. The mobile unit cannot receive or transmit outside of the specified times. Once the mobile unit receives the transmit/receive reservation schedule (block 605), the mobile unit's WiMAX coexistence unit can provide the transmit/receive reservation schedule to the wUSB coexistence unit (block 607). The mobile unit can then transmit and receive message bursts (or simply, messages) in the form of WiMAX packets as scheduled (block 609). If there is too much WiMAX packet traffic, it can be possible to throttle down the WiMAX packet traffic to help improve the wUSB performance (block 611). This can be achieved by reducing bandwidth reservation requests from the mobile unit, for example.

The diagram shown in FIG. 6b illustrates the operation of the mobile unit's wUSB coexistence unit. The mobile unit, after receiving the transmit/receive reservation schedule from the WiMAX coexistence unit (block 655) can determine if any wUSB traffic will overlap (collide) with WiMAX traffic (block 657). This is possible since both WiMAX and wUSB use scheduled transmissions and receptions. If there are no overlaps, then the transmission and reception of the wUSB packets can occur as scheduled (block 659). However, if some of the wUSB packets will overlap, then processing of the wUSB packets that will collide with WiMAX traffic will need to occur prior to their transmission (block 661 and block 663).

According to a preferred embodiment of the present invention, the processing of the wUSB packets that will overlap with WiMAX packets can include simply skipping (not transmitting) the wUSB packets that will cause the collision to occur (shown in FIG. 6c). The skipping of the transmission can involve aborting the transmission (block 670) and then requesting a rescheduling of the transmission (block 672). In an alternate preferred embodiment of the present invention, the frequency hopping transmission nature of wUSB can be exploited. The wUSB packets can still be transmitted, but the transmissions will not utilize frequency band hops that would lead to collisions with WiMAX packets (shown as block 675 of FIG. 6d). The skipped data can then be recovered using a built-in error recovery coding of the data carried in the packet. Alternatively, the skipped data can be transmitted in a subsequent packet.

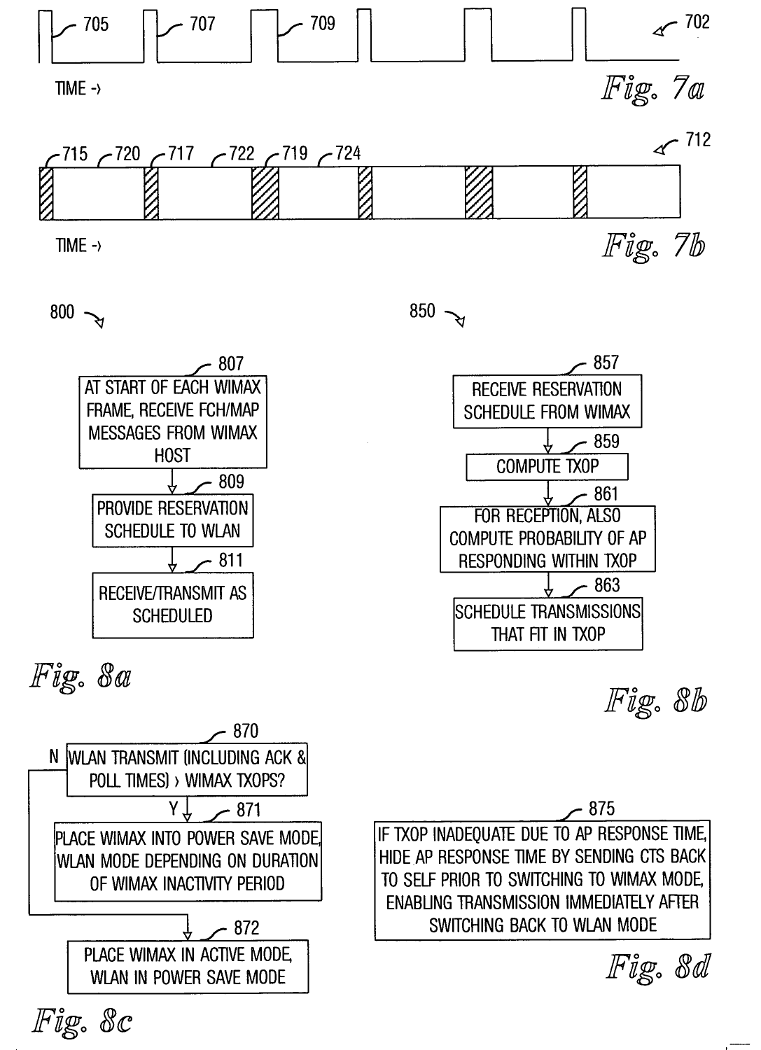

FIGS. 7a and 7b show time-space diagrams illustrating frequency band availability over time, according to a preferred embodiment of the present invention. The diagrams shown in FIGS. 7a and 7b illustrate frequency band availability over time for a mobile unit, wherein the mobile unit is actively maintaining a connection with a WLAN communications network and a WiMAX communications network. Transmission collisions can occur if the WLAN communications network and the WiMAX communications network transmit in the frequency bands at and around 2.3 Ghz & 2.5 GHz (WiMAX) and 2.4 Ghz (WLAN) or 5.8 GHz (WiMAX) and 5 Ghz (5-5.8 Ghz) (WLAN).

In WiMAX, a mobile unit can transmit and receive only when permitted to do so per a set schedule that is provided by the WiMAX base station. Additionally, since WiMAX is typically a pay for use communications system over licensed spectrum, WiMAX communications should be given priority over WLAN communications. The diagram shown in FIG. 7a displays a first trace 702 that can be representative of scheduled WiMAX transmission and reception times for the mobile unit, with pulse 705, pulse 707, and pulse 709, representative of scheduled WiMAX transmissions and receptions. The mobile unit can receive its WiMAX transmission and reception schedule from the WiMAX base station via MAP messages.

Since the WiMAX transmissions and receptions can occur only at scheduled times, the unscheduled times can be used for WLAN packet traffic. The diagram shown in FIG. 7b displays a second trace 712 that shows frequency band availability over time for transmission and reception of WLAN packets. Certain times cannot be used to transmit and receive WLAN packets, such as times reserved for transmitting and receiving WiMAX packets (shown in FIG. 7a as pulse 705, pulse 707, and pulse 709). The reserved times are shown in FIG. 7b as dashed boxes 715, 717, and 719. However, any remaining time can be used by the mobile unit to transmit and receive WLAN packets, for example, boxes 720, 722, and 724.

With reference now to FIG. 8a through 8d, there are shown diagrams illustrating sequences of events in the operation of a mobile unit's WiMAX coexistence unit (sequence of events 800, FIG. 8a) and a mobile unit's WLAN coexistence unit (sequence of events 850, FIG. 8b), as well as a determination of operating modes of the WiMAX and WLAN portions of the mobile unit, and an exemplary embodiment for processing WLAN transmissions that are too long in duration to fit within the time between WiMAX packets, according to a preferred embodiment of the present invention.

The diagram shown in FIG. 8a illustrates the operation of the mobile unit's WiMAX coexistence unit. According to a preferred embodiment of the present invention, the mobile unit can operate in one of two WiMAX modes, an active mode where the mobile unit can actively receive and transmit WiMAX packets and a power savings mode that is composed of activity and inactivity periods where the mobile unit can place its WiMAX circuitry into a low power mode for a specified amount of time.

The mobile unit can transmit and receive WiMAX packets only during specified times. The WiMAX base station, to which the WiMAX unit (the mobile unit) is communicating, can transmit a transmission and reception schedule to the mobile unit, for example, in a MAP (Media Access Protocol) message at the beginning of each WiMAX frame. Therefore, at the beginning of each WiMAX frame, the mobile unit should be able to receive WiMAX transmissions from the WiMAX base station (block 807). Hence, a specified amount of time corresponding to the beginning of each WiMAX frame should be reserved for the mobile unit to receive the reservation schedule. With the reservation schedule from the WiMAX base station, the mobile unit's WiMAX coexistence unit can provide the reservation schedule to the mobile unit's WLAN coexistence unit (block 809). The mobile unit can then transmit and receive message bursts (or simply, messages) in the form of WiMAX packets as scheduled (block 811).

The diagram shown in FIG. 8b illustrates the operation of the mobile unit's WLAN coexistence unit. According to a preferred embodiment of the present invention, the mobile unit will operate in a WLAN power save mode and the mobile unit's WLAN coexistence unit can receive a transmission and reception reservation schedule from the mobile unit's WiMAX coexistence unit (block 857). Any unreserved time can be used to for WLAN packet traffic, so transmission opportunities (TXOPs) can be computed based on the reservation schedule provided by the mobile unit's WiMAX coexistence unit (block 859).

For reception of WLAN transmission purposes, the mobile unit's WLAN coexistence unit can also keep track of the AP's response time to poll packets or UPSD (Unscheduled Power Save Delivery) packets. Based on tracking information of the AP's response times, the WLAN coexistence unit can send poll or UPSD packets to the AP only if the probability of the AP responding with a downstream packet within the TXOP is within a predetermined threshold, for example, 90 percent (block 861). If the probability meets or exceeds the predetermined threshold, then the poll or UPSD packet will be sent to the AP as well as any other transmissions that can be completed within the TXOP (block 863).

The diagram shown in FIG. 8c illustrates a sequence of events in the determination of the operating modes of the WiMAX and WLAN portions of the mobile unit. According to a preferred embodiment of the present invention, the operating mode of the WiMAX and the WLAN portions of the mobile unit can be dependent on the typical durations of unreserved periods between WiMAX transmissions, i.e., WLAN TXOPs, and a maximum expected duration of a WLAN transmission, which includes the time required for the transmission of acknowledgment and poll packets, with the WLAN transmission being a function of packet size and transmission data rate.

The determination of the operating mode can begin with a comparison of the WLAN transmit time (including acknowledgement and poll packets) with the typical (average) duration between WiMAX transmissions, also referred to as a WLAN TXOP (block 870). If the WLAN transmit time is greater than the typical duration between WiMAX transmissions, then the WiMAX portion of the mobile unit can be placed into a power save mode while the WLAN portion of the mobile unit can be placed into either an active mode or a power save mode depending on the duration of the time of the power save mode of the WiMAX portion (block 871). If the WLAN transmit time is less than the typical duration between WiMAX transmissions, then the WiMAX portion of the mobile unit can be placed into an active mode while the WLAN portion of the mobile unit can be placed into a power save mode (block 872).

Depending on the pattern and distribution of WiMAX reservations, it may not be possible to successfully complete a poll or UPSD cycle, i.e., the TXOPs are too short. If the TXOPs are too short due to AP response time, it is possible for the mobile unit to effectively lengthen the TXOP by transmitting a poll or UPSD packet at the beginning of a TXOP and then sending a CTS packet at the end of the TXOP, immediately prior to switching back to WiMAX mode. This can block any WLAN transmissions until the next time the mobile unit switches back to WLAN mode. Once the mobile unit switches back to WLAN mode, the AP can transmit the response to the poll or UPSD packet (block 875 of FIG. 8d).

The mobile unit alternating between WiMAX mode and WLAN mode can permit the sharing of certain hardware. For example, since the mobile unit can only be in one mode at a time, a single multimode transceiver (transmitter and receiver) is needed, as well as a single antenna. Additionally, the WiMAX coexistence unit and the WLAN coexistence unit, along with their respective MAC controllers, can be implemented in a single communications unit. An example of this reduction in hardware is illustrated in FIG. 2b, discussed previously.

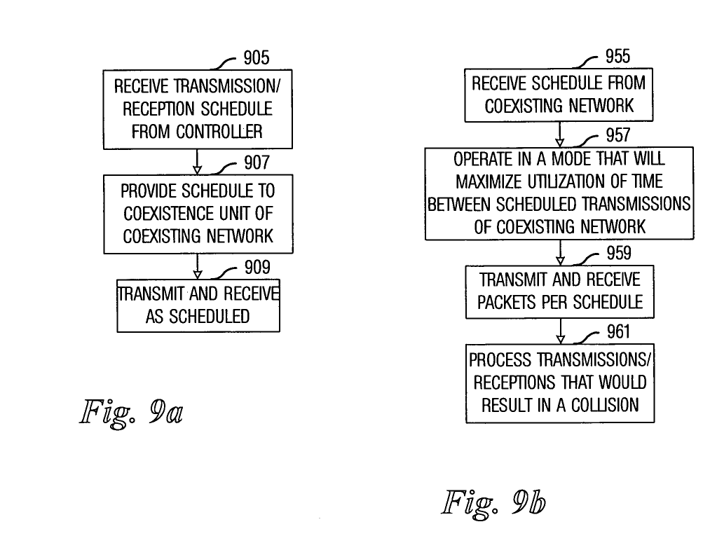

FIGS. 9a and 9b show diagrams illustrating high-level views of the operations of coexistence units in a mobile unit, wherein the mobile unit has established connections to two wireless communications networks, according to a preferred embodiment of the present invention. Preferably, one of the two wireless communications networks can transmit and receive only within scheduled times, wherein the scheduling of the times can be performed by a controller (a base station or a host, for example) for the wireless communications network. With one of the two communications networks communicating only during scheduled times, the other communications network is free to use any of the unscheduled times to communicate.

The diagram shown in FIG. 9a illustrates the operation of a coexistence unit of a mobile unit for a first wireless communications network, wherein the first wireless communications network communicates only during scheduled times. If both wireless communications networks communicate during scheduled times, then a different prioritizing methodology can be used to select the first network, such as cost of data bandwidth, licensed versus unlicensed spectrum, flexibility of MAC layer, and so forth. The operation of the coexistence unit of the first wireless communications network can begin with the reception of a transmission/reception schedule from a controller of the first wireless communications network (block 905). The transmission/reception schedule can then be provided to a coexistence unit of a second communications network (block 907) and then packet traffic of the first wireless communications network can be received and transmitted as scheduled (block 909).

The diagram shown in FIG. 9b illustrates the operation of the coexistence unit of a mobile unit for the second wireless communications network. The operation can begin with the coexistence unit of the second wireless communications network receiving the schedule of transmissions and receptions from the coexistence unit of the first wireless communications network (block 955). Based on the schedule, the operation of the mobile unit with the second wireless communications network can be determined (block 957). For example, if the scheduled traffic is heavy, then the mobile unit can be placed in an operating mode that will reduce its own traffic. Alternatively, if the scheduled traffic is light, then the mobile unit can be placed in an operating mode that can maximize data throughput and flexibility.

The transmissions and receptions of packets from the second wireless communications network can be performed based on the reservation schedule provided by the coexistence unit of the first wireless communications network (block 959). If there is a need to transmit or receive a packet that would result in a collision, then additional processing can be performed to help reduce the probability of collision or reduce the effects of the collision (block 961). For example, the packet can be broken up into multiple smaller packets and transmitted using frequencies that would not result in a collision or the packet can be sent at a later time.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for operating a mobile unit, the mobile unit capable of communicating with a first wireless network and a second wireless network, the mobile unit including a first coexistence unit associated with the first wireless network and a second coexistence unit associated with the second wireless network, the method comprising:
receiving, at the second coexistence unit, a schedule of reserved message transfer times from the first coexistence unit;
selecting an operating mode based on the schedule, the operating mode being selected by the second coexistence unit; and
transferring messages on the first wireless network and the second wireless network based on the schedule, wherein a first wireless network communicates only during scheduled times.

2. The method of claim 1 further comprising, after the transferring, altering a message burst transfer in response to a determination that the message burst transfer will result in a collision.

3. The method of claim 2, wherein the altering comprises partitioning the message burst transfer into a transfer of two or more messages bursts.

4. The method of claim 2, wherein the second wireless network transmits using a sequence of changing frequencies, and wherein the altering comprises eliminating frequencies from the sequence that will result in a collision.

5. The method of claim 4, wherein eliminating frequencies comprises not transmitting a portion of data, wherein the portion of data is recovered using an error correcting encoding of data that is transmitted.

6. The method of claim 2, wherein the altering comprises:
completing a transfer of a first portion of the message burst prior to a reserved message transfer time; and
completing a transfer of a remainder of the message burst after the reserved message transfer time.

7. The method of claim 2, wherein the altering comprises forcing a portion of the mobile unit communicating with the first wireless network into an inactive state for a time span substantially equal to or greater than a time required to transfer the message burst.

8. The method of claim 1 further comprising, prior to the receiving, receiving a message from a controller of the first wireless network, wherein the message comprises the schedule of reserved message transfer times.

9. The method of claim 1, wherein the first wireless network is a wireless USB compliant network and the second wireless network is a wireless local area network (WLAN).

10. The method of claim 9, wherein transferring messages comprises controlling the mobile unit such that a response packet in the second wireless network is transferred only at times not reserved for a high priority packet transfer in the first wireless network.

11. The method of claim 1, wherein the first wireless network is a WiMAX compliant network and the second wireless network is a wireless USB compliant network.

12. The method of claim 1, wherein the first wireless network is a WiMAX compliant network and the second wireless network is a wireless local area network (WLAN).

13. The method of claim 12, wherein receiving a message transfer comprises:
computing a probability that an access point of the second wireless network will respond within a transmission opportunity, the transmission opportunity comprising a time duration between adjacent reserved message transfer times; and
initiating the receiving message transfer only if the probability exceeds a predetermined threshold.

14. The method of claim 13, wherein the computing makes use of historical data tracking a response time of the access point.

15. A method for allowing a mobile unit to communicate with two wireless networks, wherein communications on a first wireless network occurs only during scheduled times, the method comprising:
receiving a message from a controller of the first wireless network, wherein the message contains a schedule of message transfer times;
providing the schedule to a coexistence unit for a second wireless network in the mobile unit, wherein message transfers on the second wireless network are based on the schedule;
transferring messages over the first wireless network based on the schedule; and
transferring messages over the second wireless network based on the schedule.

16. The method of claim 15, further comprising, after the transferring of messages over the first wireless network, reducing a number of message transfers in the first wireless network on a determination of poor message transfer performance on the second wireless network.

17. The method of claim 16, wherein the reducing comprises requesting less bandwidth from the controller.

18. A communications device comprising:
a communications block coupled to an antenna, the communications block configured to receive and transmit signals via the antenna; and
a communications unit coupled to the communications block, the communications unit configured to alternatively communicate with a first device via a first wireless network and communicate with second device via a second wireless network, wherein a time when the mobile unit communicates using the first wireless network does not overlap with a time when the mobile unit communicates using the second wireless network.

19. The communications device of claim 18, wherein the communications unit comprises:
a MAC controller that alternatively interfaces with the first wireless network and the second wireless network; and
a coexistence unit coupled to the MAC controller, the coexistence unit configured to coordinate timing of message transfers by the MAC controller via the first and second wireless networks.

20. The communications device of claim 18, wherein the first wireless network and the second wireless network communicate over frequency bands that are in close proximity.
